(19) United States
(12) Patent Application Publication
(10) Pub. No.: US 2005/0175181 A1
(43) Pub. Date: Aug. 11, 2005

(54) Method and system for access to data and/or communication networks via wireless access points, as well as a corresponding computer program and a corresponding computer-readable storage medium

(76) Inventors: Magnus H. Bergs, Reykjavik (IS); Djamshid Tavangarian, Rostock (DE)

Correspondence Address: Norris, McLaughlin & Marcus P.A., 30th Floor, 220 East 42nd Street, New York, NY, 10017, US

(21) Appl. No.: 10/936,460

(22) Filed: Sep. 7, 2004

(30) Foreign Application Priority Data
Sep. 5, 2003 (DE) 103 41 872.5

(51) Int. Cl. H04K 1/00

(52) U.S. Cl. 380/270

(57) ABSTRACT

The invention relates to a method and a system for access to data and/or communication networks via wireless access points, as well as a corresponding computer program and a corresponding computer-readable storage medium, which can be employed, in particular, to enable roaming with mobile terminals between hotspots in the hotspot network of an individual provider and/or between hotspots of different providers. The invention further provides a central support, service and organization center, which includes billing, authentication and accounting systems (BAA). In this way, users of mobile communication terminals obtain standardized, secure, mobile Internet access when changing WLAN hotspots. Existing hotspots are used for access to the Internet. An operator (provider) of a hotspot gains additional customers. Users registered with the BAA system obtain standardized Internet access. In addition to simple access, other value-added services can also be offered. The services are billed via the BAA system.

The invention is directed to a method and a system for access to data and/or communication networks via wireless access points, as well as a corresponding computer program and a corresponding computer-readable storage medium which, in particular, can be used with mobile-terminals to enable roaming between hotspots in a hotspot network of a single provider and/or between hotspots of different providers.

Users of mobile communication terminals obtain broadband Internet access via so-called Wireless Local Area Network hotspots (WLAN hotspots). Such WLAN hotspots include one or several WLAN access points according to the Standard IEEE 802.11b/g/h, or Bluetooth, Ultra-Wideband (UWB) transmission, or other wireless transmission protocols, such as for example IEEE 802.16 (WiMAX).

After the introduction of the third generation mobile systems using UMTS, systems for the fourth-generation are now being designed. These systems include different access systems and are intended to provide the end-user with a high bandwidth and an improved performance for data transmission. The fourth-generation systems provide user access based on a core network and a common IP-enabled platform. The future mobile systems operate across systems and layers by way of horizontal and vertical handover. The 4G-activities have as a common goal to offer all users worldwide the entire service variety across networks.

A WLAN/Bluetooth hotspot (also referred to as hotspot in short) is an area which is “illuminated” with one or several WLAN access points (AP) for wireless access to an intranet or to the Internet. The APs are connected to the wired communication network via routers/switches. Hotspots have already been established, for example, in hotels, airports, restaurants, cafes, shopping centers, and also in airplanes, trains, ships, etc. Users with mobile terminals, such as notebooks or PDAs, can access this network, as long as these devices have as an interface a WLAN/Bluetooth card or a corresponding embedded function, to send e-mails, to work on company documents, to surf the net, to access information, or to play games or view videos. Each hotspot has currently its own access and billing method when clients use the corresponding services and resources. Some hotspots use a prepaid method for payment (voucher and the like), while others use a postpaid method (invoice, credit card, and the like). Moreover, a change from one hotspot to another hotspot involves changing the IP address. To obtain access with different hotspot operators, the user may have to enter into separate contracts with a number of operators, provide separate access information (password, IP addresses, safety mechanisms, and the like), and adhere to the rules imposed by the hotspot operator.

It is therefore impossible to roam between hotspots of different operators.

A generic WLAN architecture is disclosed in the German published patent application DE 100 43 203 A1, which discloses a method and a system for using several networks of different types, for example the use of data networks (WLAN) by logging in via a cellular mobile telephone network (GSM), whereby one of the networks generically provides logical functions of components of the respective other network.

The international patent application WO 03/032618 A1 “Integration of Billing between Cellular and WLAN Networks” describes integration of a billing system between cellular and WLAN networks. This solution enables mobile telephones (GSM/GPRS) to log into data networks (LAN) via cellular networks. A (temporary) account is established in the data network, which determines the charges and subsequently transmits the charges to the billing system of the cellular network. However, this solution does not enable movement between log-in points of different providers of the cellular networks while using the networks.

The German published patent application DE 101 52 572 A1 titled “Method and device for authenticated access of a station to local data networks, in particular wireless data networks” describes a method and a corresponding device which enable authentication in the wireless data network by transmitting to a user access information for accessing the wireless data network via a telecommunication network that is separate from the wireless data network, in particular by way of SMS(=Short Message System) via a mobile telephone network.

The German published patent application DE 101 37 551 A1 titled “Prepaid use of special service offers” proposes a system, whereby services of a server located in a telecommunication network can be used, after a user account and a user credit balance have been established on the server. In particular, a prepaid method is used.

It is therefore an object of the invention to provide a method and a system for access to data and/or communication networks having wireless transmission links, as well as a corresponding computer program and a corresponding computer-readable storage medium, which obviates the aforementioned disadvantages and, in particular, enables centralized, standardized access to the owner's hotspots and/or to hotspots of different providers.

The object is solved according to the invention by the features recited in claims 1, 12, 14, and 15. Advantageous embodiments of the invention are recited in the dependent claims.

The object according to the invention is solved by a proposed method for access to data and/or communication networks via wireless access points, such as for example hotspots, wherein a first computer program is installed on at least one data processing device connected with the data and/or communication network(s) as a central management system for controlling a standardized usage of the data and/or communication network(s), and a corresponding second computer program is installed in at least a portion of the access points to the data and/or communication network(s), wherein the second computer program enables communication terminals to log on the (a) data and/or communication network with access data that are independent of the providers of the access points and adapted to the central management system (transparent access), in that the second computer program sets up a connection (session) between the terminal of a user and the central management system depending on the access data of the user of the data and/or communication network(s), and a transition (roaming) between access points is transparently controlled by the first and/or second computer program for communication terminals.

In an advantageous embodiment of the method of the invention, roaming takes place between access points of different providers. The method according to the invention has the advantage that the users of the data and/or communication networks can use standardized, provider-independent access data for gaining access via hotspots.

A system for access to data and/or communication networks via wireless access points, such as for example hotspots, is characterized in that the system includes
at least one data processing device which is connected with the data and/or communication network(s) and configured as a central management system for controlling a standardized usage of the data and/or communication network(s),
access points to the data and/or communication network(s), which are configured so as to enable communication terminals to log on the data and/or communication network(s) with access data that are independent of the providers of the access points and adapted to the central management system (transparent access), in that a connection (session) is established by the second computer program between the terminal of a user and the central management system depending on the access data of the user of the data and/or communication network(s),
   and data processing device(s) and/or access points are arranged so that a transition (roaming) between access points for communication terminals is implemented transparently.

According to an advantageous embodiment of the method of the invention, the data and/or communication networks are accessed via a WLAN interface.

According to another advantageous embodiment of the method of the invention, when a user logs on, the second computer program installed at the access point that is used for the login attempts authentication at the central management system.

In another advantageous embodiment of the method of the invention, after successful authentication, the data required for billing of utilized services, such as the duration of the session or the volume of the transmitted data, are determined and stored in a central database.

Advantageously, the central management system provides the value-added services, such as e-mail accounts, video streaming, audio streaming and/or telephony via the Internet.

Moreover, a user, after logging on to the central management system and depending on the access data, can advantageously use services provided by a provider of an access point to the data and/or communication networks.

Advantageously, the central management system includes an inherent billing system, wherein the billing system automatically generates invoices, performs financial transactions, monitors payment transactions and/or sends out dunning letters.

According to another advantageous embodiment of the method of the invention, the billing system bills for the use of services, which are provided by a provider of an access point to the data and/or communication networks, but not by the central management system.

In addition, at least a portion of the user data stored in databases of the central management system can advantageously be processed by the user (customer self-care).

In a particular advantageous embodiment of the system of the invention for access to data and/or communication networks via wireless access points, it is provided that at least one data and/or communication network includes
a Wireless Local Area Network (WLAN),
an Ultra-Wideband-Net and/or
a mobile telephone network
   and/or includes communication links in
Bluetooth and/or
other wireless technologies, such as for example WiMAX.

A computer program for access to data and/or communication networks via wireless access points, such as for some hotspots, enables a computer, after the computer program is loaded into the memory of the computer, to execute a method for accessing data and/or communication networks via wireless access points, wherein
log on of the communication terminal to the (a) data and/or communication network is enabled with access data which are independent of the providers of the access points and adapted to the central management system (transparent access),
a connection (session) between the terminal of a user and the central management system is set up depending on the access data of the user of the data and/or communication network(s), and
   a transition (roaming) between access points is transparently controlled by the first and/or second computer program for communication terminals.

For example, these computer programs can be provided for downloading in a data or communication network (either with or without a fee, or freely accessible or protected by a password). The computer programs provided in this way can be used by a method, wherein a computer program according to claim 14 is downloaded from an electronic data network, for example from the Internet, to a data processing device connected to the data network.

Advantageously, for access to data and/or communication networks via wireless access points, such as for some hotspots, a computer-readable storage medium, on which a program is stored which enables a computer, after the computer program is loaded into the memory of the computer, to execute a method for accessing data and/or communication networks via wireless access points, wherein
log on of the communication terminal to the (a) data and/or communication network is enabled with access data which are independent of the providers of the access points and adapted to the central management system (transparent access),
a connection (session) between the terminal of a user and the central management system is set up depending on the access data of the user of the data and/or communication network(s), and
   a transition (roaming) between access points is transparently controlled by the first and/or second computer program for communication terminals. Advantageously, the storage medium includes several modules, for example, several CD-ROMs or storage disks, etc., wherein the first computer program representing the central management system and the second computer program(s), which are installed at the access points, are stored separate from each other.

It is proposed to operate the system according to the invention in that the central management system is provided by an operator,

the operator enters into agreements with the providers of the access points to the data and/or communication networks regarding usage of the access points by the operator and/or into agreements about usage by the providers of the services provided by the central management system, wherein the agreements include corresponding payment agreements,

the operator enters into agreements with users (clients) of the data and/or communication networks concerning access and use of the network, wherein the agreement includes distributing to the user(s) access data adapted to the central management system for transparent access to the data and/or communication networks and performing a transparent transition (roaming) by the operator between access points of different providers, as well as corresponding payment agreements.

In advantageous embodiment, it is provided that

the agreement between the operator and the provider is implemented as a contract for a predetermined time duration, wherein the contract stipulates an amount to be paid by the operator to the provider, the amount resulting from

the resources of the provider utilized by the operator and the transmitted data volume,
as a flat sum payment for each client of the operator working at an access point of the provider, and/or
as a portion of the revenue of the operator from flat sum payments of the clients,
   and/or
   the agreement between the operator and the client is implemented as a contract for a predetermined time duration, wherein the contract provides
distribution of access data free of charge by the operator to the client, and
payment of usage fees by the client to the operator,
   wherein the amount of the usage fees to be paid by the client to the operator is determined as follows:
as a monthly flat fee which includes free usage of the offered services and user access,
from the number of the services used by the client and/or the transmitted data volume and/or
from the online time of the client.

An embodiment of the invention will be described hereinafter with reference to the drawings.

the invention for broadband access to the Internet via WLAN hotspots of different providers will now be described with reference to an example. However, the invention is not limited to this application and can also be used for access to mobile telephone networks of different operators.

It is shown in:

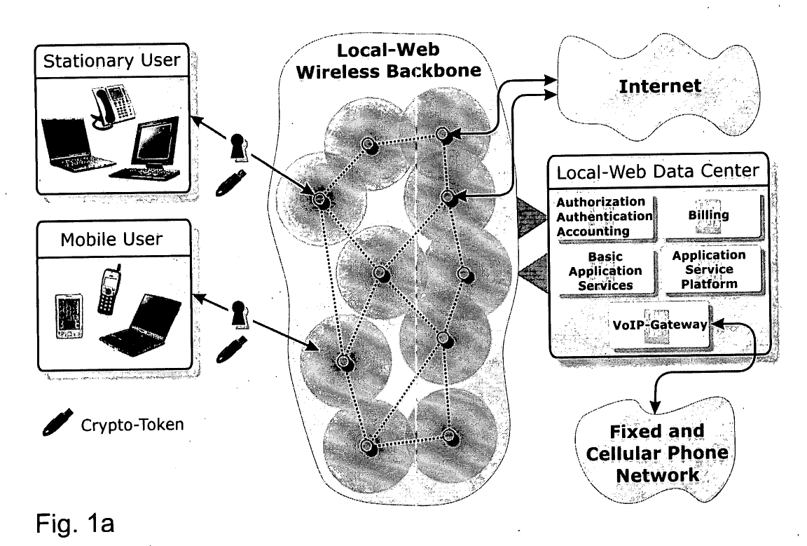

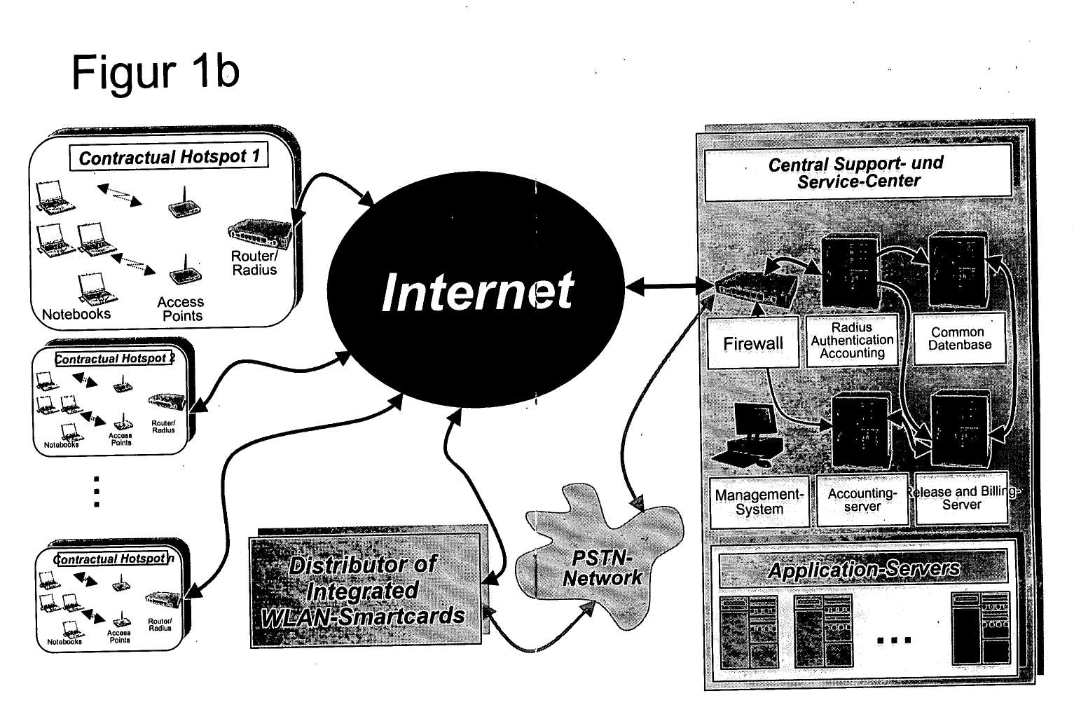

FIGS. 1, 1b exemplary diagrams of the system architecture of the system for centralized access to data and/or communication networks via WLAN/UWB hotspots; and

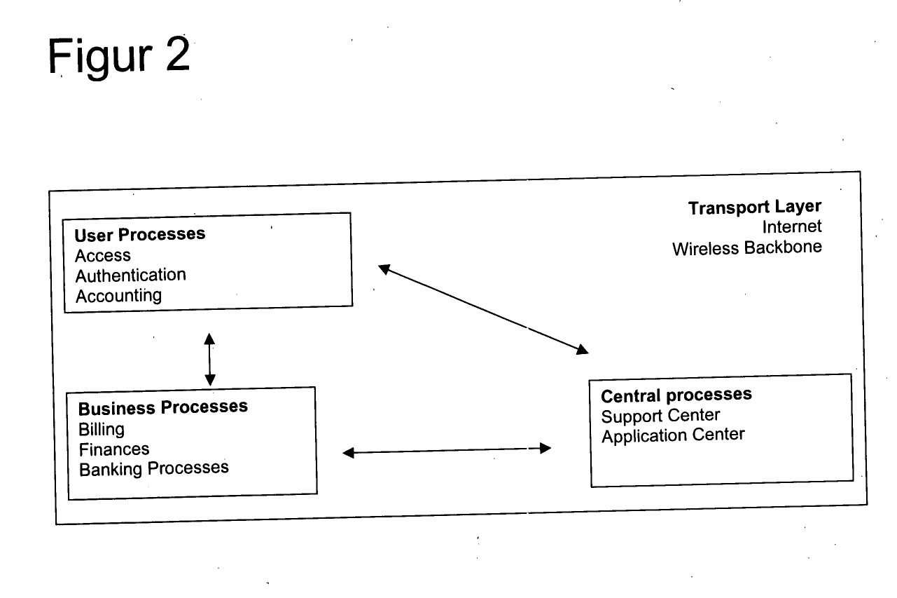

FIG. 2a visualization of the communication between processes running in a central support, service, and organization center.

To implement centralized access to data and/or communication networks via WLAN/Bluetooth hotspots, a system architecture with a centralized support and service center (central service location for hotspots) is proposed, which checks access authorizations of users with, for example, a specially designed proxy (RADIUS-proxy) which is installed at the hotspot, bills the charges for the clients and for the hotspots, and offers comprehensive support and services. Exemplary implementations are illustrated in FIGS. 1a and 1b.

Standardized access is provided by authentication hardware, wherein the authentication hardware can be implemented with smartcards in different modifications: for example PCMCIA, USB, or an inherent smartcard format. Alternatively, the authentication hardware can be integrated in the client (for example as a WLAN card). In the following, the exemplary embodiments are described with reference to a WLAN interface with smartcard functionality, wherein the WLAN interface is combined with the smartcard functionality into a single unit. Those skilled in the art will understand that the invention is not limited to this exemplary embodiment. The WLAN interface with integrated smartcard functionality can be used for a centralized verification by employing private secret keys to provide secure, authorized network access for a client. The concept offers the highest degree of security, integrity and transparency of the system for the user while communicating and exchanging data via the Internet.

From this central location contracts can be signed, on one hand, with the individual hotspot operators to provide contractual hotspots so that their resources can be used by a certain group of clients, regardless which Internet provider or other provider is involved, and on the other hand, with the respective users in the owner's dedicated hotspot networks. These users represent the above-mentioned group of clients. A user receives authentication data for access. Advantageously, to prevent tampering, these data can be securely included in hardware, for example, in special authentication hardware, such as a smartcard USB token or a PCMCIA card, in particular an integrated WLAN (hotspot) smartcard as a WLAN interface card, whereby the user gains access at the contractual hotspots through authentication and accounting (identification of the user) and billing (payments). In this way, the user can remain mobile without restrictions, can always transparently obtain access to the Internet, and can download at the installed contractual hotspots, for example, presentations, can send and receive e-mail, or view a video. Accordingly, horizontal handover between the various hotspots is enabled.

The center offers diverse services (even games and movies) to increase the attractiveness for the user.

The operator of a contractual hotspot is paid for the resources used by the client at the hotspot.

The components of the system include:
a central support and service center which includes
an access server with firewall functionality for secure authorization of clients or users on the basis of the integrated WLAN/Bluetooth smartcard interface system of the user (it will be understood that any other technology can be used for wireless communication instead of WLAN or Bluetooth, in particular any other wireless technology),
a database for storing, on one hand, the data and the profiles of the registered users and, on the other hand, the data of the contractual hotspots,
a release server with RADIUS functionality which in the event of a successful access verification unblocks the subscribed services in this central region for the user (client) and provides the necessary resources at the hotspot operator, and informs the billing system to debit the services used by the client and credit the used resources to the hotspot operator,
a number of application servers that provide different services for use by the clients,
a billing system with a billing and accounting server for billing and/or invoicing the used services and/or for crediting the hotspot operators,
a server for accounting and for collecting the charges in cooperation with a bank,
an administration site for monitoring the organization and administration of the entire system.
The owner's hotspot networks and/or contractual hotspots which each include the following components:
one or several APs which enable WLAN/Bluetooth access,
interfaces to the Internet via a server or routers/switches,
a proxy at contractual hotspots for identifying the different clients and initiating the secure check and the secure network access through the center for the own clients.

Users or clients which each have an integrated WLAN Bluetooth interface with smartcard functionality for their notebook, palmtop, etc., for secure access to the network and are registered in the center.

In the following, a number of important processes will be described with reference to examples which operate on different components of the exemplary system for centralized Internet access on the basis of a wireless network.

The client is located at an arbitrary hotspot or in a hotspot network. Access is provided via the corresponding provider. The installed RADIUS proxy attempts authentication with the center (BAA). If the attempt is successful, then the BAA system performs the billing. Otherwise, billing is done through the provider. For example, secure methods, such as IEEE 802.1x or EAP/TLS are used for authentication. For example, a specially modified WLAN card or other authentication hardware, as described above, which performs the authentication automatically, is used to provide uncomplicated access for clients. This hardware (card) can be obtained when signing the contract.

The RADIUS server represents the access point of the system on the side of the center. It receives the authentication requests from the corresponding hotspots and processes these requests. The required data are stored in the common database. After successful authentication, a new connection (session) is created for the client. This session is monitored with the help of accounting components of the RADIUS server. At the end of the session, the data required for billing, such as the duration of the connection, the volume of the transmitted data, or the use of other billable services, are stored in the common database. The billing system accesses these data and generates corresponding invoices. The billing system also monitors payments and optionally intervenes in a regulatory fashion (dunning). The management system provides a user interface (GUI) for controlling the components of the center.

Processes

The processes used by the system can be subdivided into
User processes
Business processes
Central processes.

These processes communicate with each other, as seen in FIG. 2.

User Processes

All processes where the clients are addressed directly, are referred to as user processes. They include:

Access

Authentication

On the client side, special authentication hardware, for example a WLAN card, is used for authentication. Unique identification is possible through a modification of the firmware. The corresponding keys and certificates are stored in this card. The access points of the hotspots must support the RADIUS protocol.

Accounting

The accounting functionality of the RADIUS protocol forms the basis. Accordingly, the access points of the hotspots must also support RADIUS for accounting. After successful authentication, a session is set up. All data required for the subsequent billing can be determined based on this session. This includes the duration of the session and the volume of the transmitted data. In addition, the session management prevents multiple, simultaneous use of the Internet access by a client.

Value-Added Services

Value-added services refer to those services that go beyond the actual Internet access. These can include, for example, video streaming, but also an e-mail account for the client.

General Services

General services are available to all clients at any hotspot that is embedded in the architecture. Such services could include video streaming, audio streaming, or telephony via the Internet. Billing is performed by the billing system.

Individual Services

These services are specifically allocated to a client. An example for individual services is an e-mail account for the client. Moreover, profiles of the client can be acquired to make special offers, for example, for selecting available videos.

Local Services

These services are associated with specific hotspots. Local services could include information about events or menus from a restaurant. They are useful only in the vicinity of the hotspot.

Business Processes

Business processes refer to all processes that are directed to billing, contractual agreements, finances etc.

Finances

Billing

Billing combines all processes required for accounting for the services used by the client.

Generating Invoice Data

The invoice data are generated on the bases of the session data obtained from accounting. An important point is hereby the independence from particular currencies, because the entire system is intended for use in different countries. Different taxation rules also have to be taken into account. The session data are therefore transformed in a first step into currency-independent “credits.”. The transformation can take place in several ways.

Time-Dependent Models

In these models, a particular time unit is associated with a “credit.” If an allocated limit is exceeded, then the charged amount can be increased or access can be blocked.

Volume-Dependent Models

Similar to the time-dependent models, a certain data volume is associated with a “credit.” If the volume is exceeded, mechanisms similar to those in the time-dependent models are employed.

Flat Rates

With flat rates, a flat fee is charged for access to the Internet.

Content-Based Models

These models are used to bill for offered value-added services. Corresponding “credits” are associated depending on the attractiveness of the service.

Mixed Forms

Of course, the aforementioned models can also be used in combination.

Generating Invoices

After the accounting data have been generated, the actual invoices can be produced. A corresponding accounting model must be used as a basis.

For example, there exists

Prepaid

With prepaid models, invoicing is done before the actual services are performed. One example of vouchers which are issued before the service is performed.

Postpaid

According to this model, payment is made after the services have been rendered.

Models

Accordingly, an invoice or other information is produced about the client's credit balance. The “credits” are converted into the corresponding local currency and the local tax rate is applied.

Bank Processing

The payment processes for the corresponding accounts are monitored by a financial accounting system. The customer information is updated based on the received payments. If payments are not made, dunning is activated.

Dunning

If payments are not received, dunning letters are sent to the client. To secure the outstanding balance, the corresponding access is temporarily blocked.

Contracts

Hotspot Provider

The business relationships with the providers that make their hotspots available to the network have to be contractually secured. Administration of the providers occurs within the system.

Clients

After approval of a corresponding application, the client is accepted into the system. The contract must also include, for example, data about the billing model; however, later changes are possible.

Central Processes

These include all processes that are provided to the client by the network operator.

Support Center

This site solves problems encountered by the client. This is accomplished, for example, through

Customer Self-Care

The client is provided by a corresponding interface (Web front end) with a limited opportunity to correct his data.

Call Center

Changes of the client data exceeding those provided within the context of Customer Self-Care must be processed by the staff in the call center.

Application Center

The application center performs all value-added services (see user processes).

Database Processes

A central database stores the data for all processes for the client as well as for the providers.

The clients obtain, for example, the integrated WLAN/UWB smartcard interfaces either without charge or, alternatively, by paying a fee. In return, they sign a contract with the central site for a certain time (e.g., for two years, similar to GSM contracts). The user or client pays a monthly fee, which is paid to the center by automatic debit transfer. The amount of the charges can be determined by different methods:
in form of a monthly flat fee which includes free usage of the offered services and user access with a flat rate,
an amount which depends on the volume of the services used by the client and the transmitted data volume,
an amount which depends on the time the client was online, or
a mix of the aforementioned methods.

The client has then the option or the right to obtain transparent, trouble-free and secure Internet access in all contractual hotspots. In addition; the client is entitled to use the free services provided by the center. These can extend, for example, to computer games, which can change on a monthly basis, information portals, news services, VIP services, etc.

It is a particular advantage of the method that the marketing approach is known to both the client and the operator of cards, thus obviating the need for extensive training. The cards can be distributed by all retail outlets that sell GSM systems (handies), because they represent an additional business without requiring additional investment. A user is registered from these outlets via a modem connection, via secure Internet access, or via telephone, as is customary with handies.

The method represents additional business also for the hotspot operators which intend to sign a contract with a central support and service center, because they gain new customers. They also need not change their local systems or adapt the systems to particular regulations. The central site only requires access to install a proxy, which can be remotely installed by the center.

Payment to the hotspot operators can also be made according to different methods:
the hotspot operator receives an amount according to the volume of utilized resources and the transmitted data volume,
for each user operating in a hotspot, a flat fee is paid according to different criteria (online time, sessions, etc.).
the total revenue of the support and service center paid by the client as a flat fee is divided between all participants as a percentage based on certain parameters. For example, 40% can be allocated to the support and service center, and 60% to the hotspot operators, whereby the hotspot operators that serve more clients receive a higher amount.

Both clients and hotspots from different regions can participate in this concept. Potential customers are, for example, employees of companies that meet special conditions, members of communities (e.g., ADAC), and customers of service providers (e.g., AOL). Also, customers of the City/Regional Career can be gained as clients. Possible candidates for contractual hotspots are, for example, hotspot chains, network operators, City/Regional Career, mobile telephone providers (T-Mobile, O2, . . . ) ISDN providers, and the like.

The scope of the invention is not limited to the aforedescribed preferred embodiments. Instead, a number of variations are possible which can include fundamentally different embodiments that are based on the system and methods according to the invention.

1. Method for access to data and/or communication networks via wireless access points, such as for example hotspots, characterized in that
a first computer program is installed on at least one data processing device connected with the data and/or communication network(s) as a central management system for controlling a standardized usage of the data and/or communication network(s), and a corresponding second computer program is installed in at least a portion of the access points to the data and/or communication network(s), wherein the second computer program enables communication terminals to log on the (a) data and/or communication network with access data that are independent of the providers of the access points and adapted to the central management system (transparent access), wherein the second computer program sets up a connection (session) between the terminal of a user and the central management system depending on the access data of the user of the data and/or communication network(s), and
a transition (roaming) between access points is transparently controlled by the first and/or second computer program for communication terminals.

2. Method according to claim 1, characterized in that
at least one data and/or communication network is implemented as
a Wireless Local Area Network (WLAN),
anUltra-Wideband-Net and/or
a mobile telephone network
and/or includes communication links in
Bluetooth and/or
other wireless technologies, such as for example WiMAX.

3. Method according to one of the claims 1 or 2, characterized in that
roaming occurs between access points of different providers.

4. Method according to one of the preceding claims, characterized in that
the data and/or communication networks are accessed via a WLAN, Bluetooth, or WiMAX interface.

5. Method according to one of the preceding claims, characterized in that
when a user logs on, the second computer program installed at the access point that is used for the login attempts authentication at the central management system.

6. Method according to one of the preceding claims, characterized in that
after successful authentication, the data required for billing of utilized services, such as the duration of the session or the volume of the transmitted data, are determined and stored in a central database.

7. Method according to one of the preceding claims, characterized in that
the central management system provides added-value services, such as e-mail accounts, video streaming, audio streaming and/or added-value services for telephony via the Internet, such as for example telephony via Voice over IP (VoIP) and/or messaging via Short Message System (SMS).

8. Method according to one of the preceding claims, characterized in that
a user, after logging on to the central management system, is enabled, depending on the access data, to use services provided by a provider of an access point to the data and/or communication networks.

9. Method according to one of the preceding claims, characterized in that
the central management system comprises an inherent billing system, wherein the billing system automatically generates invoices, performs financial transactions, monitors payment transactions and/or sends out dunning letters.

10. Method according to claim 9, characterized in that
the billing system bills for the use of services, which are provided by a provider of an access point to the data and/or communication networks, but not by the central management system.

11. Method according to one of the preceding claims, characterized in that
at least a portion of the user data stored in databases of the central management system can be processed by the user (customer self-care).

12. System for access to data and/or communication networks via wireless access points, such as for example hotspots, the system comprising:
at least one data processing device which is connected with the data and/or communication network(s) and configured as a central management system for controlling a standardized usage of the data and/or communication network(s),
access points to the data and/or communication network(s), which are configured so as to enable communication terminals to log on the data and/or communication network(s) with access data that are independent of the providers of the access points and adapted to the central management system (transparent access), in that a connection (session) is established by the second computer program between the terminal of a user and the central management system depending on the access data of the user of the data and/or communication network(s),
and data processing device(s) and/or access points are arranged so that a transition (roaming) between access points for communication terminals is implemented transparently.

13. System according to claim 12, characterized in that
the system comprises the following components:
a central management system implemented as a support and service center and comprising:
at least one access server with firewall functionality,
at least one database for storing data and profiles of registered users and/or of data of the access points encompassed by the system,
at least one release server with RADIUS functionality for unblocking services, for providing resources and/or for information from billing systems,
at least one application server for providing services,
at least one call-by-call gateway for access to at least one landline telephone network and/or mobile telephone network,
at least one billing system with a billing and/or accounting server for billing and/or invoicing of used services and/or for paying providers of the access points, and/or
at least one server for performing accounting operations and/or for collecting charges,
at least one access point to the data and/or communication networks, each access point having
at least one WLAN access point (AP) and
at least one interface to the Internet.

14. Computer program which enables a computer, after the computer program is loaded into the memory of the computer, to execute a method for accessing data and/or communication networks via wireless access points, such as for example hotspots, wherein
log-on of the communication terminals to the (a) data and/or communication network is enabled with access data which are independent of the providers of the access points and adapted to the central management system (transparent access),
a connection (session) between the terminal of a user and the central management system is set up depending on the access data of the user of the data and/or communication network(s), and
a transition (roaming) between access points is transparently controlled by the first and/or second computer program for communication terminals.

15. Computer-readable storage medium, on which a program is stored which enables a computer, after the computer program is loaded into the memory of the computer, to execute a method for accessing data and/or communication networks via wireless access points, such as for example hotspots, wherein
log-on of the communication terminals to the (a) data and/or communication network is enabled with access data which are independent of the providers of the access points and adapted to the central management system (transparent access),
a connection (session) between the terminal of a user and the central management system is set up depending on the access data of the user of the data and/or communication network(s), and
a transition (roaming) between access points is transparently controlled by the first and/or second computer program for communication terminals.

16. Method for operating a system according to one of the claims 12 or 13, characterized in that
the central management system is provided by an operator,
the operator enters into agreements with the providers of the access points to the data and/or communication networks regarding usage of the access points by the operator and/or into agreements about usage by the providers of the services provided by the central management system, wherein the agreements include corresponding payment agreements,
the operator enters into agreements with users (clients) of the data and/or communication networks concerning access and use of the network, wherein the agreement includes distributing to the user(s) access data adapted to the central management system for transparent access to the data and/or communication networks and performing a transparent transition (roaming) by the operator between access points of different providers, as well as corresponding payment agreements.

17. Method according to claim 16, characterized in that
the agreement between the operator and the provider is implemented as a contract for a predetermined time duration, wherein the contract stipulates an amount to be paid by the operator to the provider, said amount resulting from
the resources of the provider utilized by the operator and the transmitted data volume,
as a flat sum payment for each client of the operator working at an access point of the provider, and/or
as a portion of the revenue of the operator from flat sum payments of the clients.

18. Method according to claim 16, characterized in that
the agreement between the operator and the client is implemented as a contract for a predetermined time duration, wherein the contract provides
distribution of access data free of charge by the operator to the client, and
payment of usage fees by the client to the operator.

19. Method according to one of the claims 16 to 18, characterized in that
the amount of the usage fees to be paid by the client to the operator is determined as follows:
as a monthly flat fee which includes free usage of the offered services and user access,
from the number of the services used by the client and/or the transmitted data volume and/or
from the online time of the client.

20. Method according to one of the claims 16 to 19, characterized in that
the services offered by the central management system include
access to at least one landline telephone network and/or mobile telephone network,
leasing of telephone call times and/or
providing telephony services free of charge, such as for example telephony via Voice over IP (VoIP) and/or messaging via Short Message System (SMS).

21. Method, wherein a computer program according to claim 14 is downloaded from an electronic data network, such as for example from the Internet, to a data processing device connected to the data network.
